(19) United States
(12) Patent Application Publication
(10) Pub. No.: US 2013/0257645 A1
(43) Pub. Date: Oct. 3, 2013

(54) TARGET VISIBILITY ENHANCEMENT SYSTEM

(71) Applicant: Richard W. Penney, Malvern (GB)

(72) Inventor: Richard W. Penney, Malvern (GB)

(21) Appl. No.: 10/469,980

(22) Filed: Jan. 21, 2004

(30) Foreign Application Priority Data
Jan. 24, 2003 (GB) 0301614.4

(51) Int. Cl. G01S 13/50

(52) U.S. Cl. CPC G01S 13/50
USPC 342/159

(57) ABSTRACT

A method and apparatus (10) for enhancing target visibility comprises producing pulse returns in response to a sequence of received pulses. The pulse returns are processed to produce primary returns which vary from pulse to pulse unlike unmodulated clutter returns. The pulse returns are also processed to produce one or more secondary returns which model clutter artifacts whose amplitude vary with range in a manner related to the amplitude variation of the estimated clutter, and whose phase varies in a manner related to the phase of the primary returns. This is followed by removal from primary returns of a contribution thereto varying with range in the same way as the secondary returns. The result is that contributions to radar returns associated with moving targets are enhanced relative to clutter.

This invention relates to a system, a method, and a computer program for enhancing target visibility in an imaging system (such as for example a radar or sonar system) that collects return signals generated by radiation reflected from a system field of view.

Radar systems are known which operate by transmitting a train of radio frequency (RF) electromagnetic pulses into a system field of view. The pulses are usually generated by modulating and amplifying a continuously running RF source. A typical pulse train contains between 8 and 128 pulses. The system field of view is determined by the size of the radar antenna relative to the RF wavelength. Typically the system field of view is defined by a beam with an angular spread of 3 to 5 degrees.

Objects illuminated by a radar transmitter reflect a small proportion of incident pulse power back to a radar receiver. If radar transmitter and receiver are co-located, then between transmission of a pulse and receipt of its reflection from an object there is a propagation time delay equal to the round trip distance 2R divided by the speed of light c, i.e. 2R/c, where R is the range of the object from the radar. It is well known in radar how to determine object range by measuring propagation delay.

A radar antenna collects a signal incident upon it and feeds the signal to a receiver. Typically, the receiver will amplify and downconvert the incident signal to a low frequency by a signal mixing process using one or more local oscillators (LO): the low frequency signal is referred to as the radar return. The radar return is the superposition of delayed replicas of the transmitter modulation resulting from reflections from objects in a radar system field of view. A radar return collected after transmitting one pulse and before the next pulse is called a pulse return. Thus returns as a whole comprise pulse returns for a sequence of pulses. In this specification the expression “return” is used to indicate signals in a receiver irrespective of how many stages of processing and consequent transformation they have undergone following receipt.

A radar return can be represented as a sequence of samples each being a digital complex number indicating amplitude and phase. A typical sampling rate is 10⁷ samples per second. In common radar parlance samples are said to lie in discrete numbered range cells, range cell number indicating target range and being proportional to propagation delay. A sample has an amplitude which is related to the amplitude reflected from an object (or objects) associated with a range cell. A return has a phase which depends on shape and position of a reflecting object giving rise to it, and also on LO signal phase used in its downconversion. If object range changes by a distance d, the phase of the associated return changes by 47πfd/c where f is the radio frequency of the radar. This change of phase is used to estimate an object's speed along the object/radar system direction (radial speed): estimation uses a technique known as Doppler frequency measurement which measures the rate of phase change between pulses; if the measured rate of phase change is expressed as an angular frequency w, an estimate of target radial speed is ωc/4πf.

The accuracy of time delay measurement is determined by the duration of the transmitted pulse, a short transmitted pulse being required to measure range to high accuracy. For many types of power amplifier employed in radar transmitters the peak power is limited. Hence a short pulse would cause the mean transmitted power to be low and the sensitivity of the radar, that is its ability to detect a reflecting object, will also be low.

In order to circumvent the problem of low sensitivity it is well known to transmit a longer pulse with a modulation waveform varying through the pulse. One such waveform, known as a linear chirp, has constant amplitude but its frequency varies linearly with time through a pulse. The total energy transmitted in each pulse is increased because the pulse duration is longer. A return from an object varies in the same way as the modulation of a pulse giving rise to it. A received signal is filtered using a pulse compression filter: for an input signal with appropriate modulation (e.g. linear chirp), the compression filter output approximates to a short pulse. When a radar return is a sequence of digital samples, the compression filter is implemented by a digital processor that correlates the radar return with a filter weight function.

A frequent radar requirement is to pick out objects of special interest such as aircraft or ships, usually referred to as targets. In many situations returns from targets are much weaker than those from strongly reflecting background objects such as hills, rocks, buildings, and breaking sea waves. Returns from background objects are commonly referred to as clutter. Clutter returns may be 70 dB stronger than returns from small targets. If the radar itself is moving towards the background, the phases of these clutter returns may themselves vary significantly between successive pulses, even if the background objects are themselves stationary. It is well known to compensate for the bulk motion of a Doppler radar by adjusting the phase of each return according to the motion of the radar and so make the clutter returns appear stationary or have only slow variations between successive pulses.

Targets of interest may have rapid movement relative to the radar which may be used to separate their returns from clutter returns by a technique known as range-Doppler processing. Returns from different pulses but for the same range (or propagation delay) are applied to a moving target filter which is sensitive to the change in phase of a return due to target movement between pulses. It may also be possible to detect targets by recording the change in signal power in a given range-cell between successive pulses, although this is generally far less sensitive than Doppler radar.

A moving target filter can be implemented in several ways. One method involves digital processing to evaluate a Fourier transform of returns for each range. In a second method called polynomial projection, returns for each range are orthogonalised to polynomials in pulse number: the orders (highest powers of pulse number) of these polynomials vary from 0 to a chosen upper value P. Orthogonalisatibn removes components of the returns that vary slowly from pulse to pulse. A third method uses statistical information from the clutter scene to construct a family of functions of pulse-number which model typical temporal variations of the clutter. The returns are orthogonalised to this family of functions, up to a chosen order P. After suppressing the returns from clutter, one may apply a Fourier transformation to the pulses, which advantageously separates the returns into components according to their Doppler frequency.

Unfortunately, the visibility of a moving target against a background of clutter is limited by radar system imperfections even in the case of returns from stationary clutter. There are at least two ways in which a strong return from stationary clutter can obscure a moving target: unwanted modulations of the clutter returns due to instabilities in the radar system; and difficulties in designing a filter which can sufficiently sharply discriminate between moving targets and stationary clutter even given perfect radar hardware. Both these factors mean that residual signals unrelated to the target may be present after applying a moving target filter. If these residual signals are stronger than thermal noise then they raise the background from which targets must be distinguished, making them less visible.

In this specification residual signals related to strong clutter returns are termed “clutter artifacts”. Mechanisms causing unwanted clutter artifacts include:

a) transmitter oscillator phase noise;

b) local oscillator phase noise;

c) vibration, causing small phase shifts; and

d) using a moving target filter which has non-zero response to clutter returns.

It can be difficult and expensive perhaps prohibitively so to counteract these mechanisms by improved quality of engineering. It is also extremely difficult even theoretically to design moving target filters which do not produce some residual output from slow-moving clutter returns.

It is an object of this invention to enhance target visibility in an imaging system by reducing the effects of clutter artifacts.

The present invention provides an electronic signal processing system for processing signals received from a scene, including:

a) means for producing from the received signals a set of main returns representative of the scene and distributed between a plurality of range cells;

b) means for estimating a clutter component of the main returns; and

c) means for producing a set of primary returns comprising of residuals derived by removing the estimated clutter component from the main returns;
characterised in that the system is arranged to produce a set of modified primary returns by further including:

d) means for estimating a component representative of clutter artifacts manifesting as a similarity between the primary returns and either the clutter component or the main returns , and

e) means for removing the clutter artifact component from the primary returns to produce the modified primary returns having reduced clutter artifacts.

The invention provides the advantage of enhancing the visibility of moving targets by reducing the effects of clutter artifacts. It makes use of the discovery that the variation with range of the amplitudes of the clutter artifacts is often similar to the amplitudes of the clutter returns themselves. Thus a component representative of the clutter artifacts may be estimated by looking for a similarity between the primary returns and either the clutter component or the main returns, as the main returns typically largely comprises of the clutter component. The invention also exploits the observations that the variation of the amplitude of the clutter returns with range is often complicated and therefore distinctive. The invention is particularly advantageous for a radar system for which the number of range cells is large: there may be at least 100 range cells.

The invention does not require direct measurement of the imperfections within a radar system or its associated signal processing. The invention uses the assumption that such imperfections will lead to clutter artifacts which have a variation between range cells that bears a simple relation to the variation of the clutter returns, and that the clutter returns will themselves have a distinctive variation between successive range cells. As the invention uses data from actual signal returns to characterise the artifacts introduced by the system, the invention provides adaptive processing.

The invention is particularly applicable to systems incorporating signals having a pulsed structure. The invention may be applied when using a simple pulse or when the transmitted pulse is modulated in such a way that the pulse is compressible by filtering. In the case of compressible pulses, the compressed pulse returns are the main returns.

Primary returns may be generated from main returns by processing with a moving target filter and retaining pulse return components which vary from pulse to pulse in a manner unlike clutter returns. The moving target filter may be implemented by distributing pulse returns between appropriate target range cells, expanding pulse returns for each range cell in orthonormal polynomials of pulse number, selecting contributions associated with those polynomials with orders less than a non-zero threshold value to produce a contribution to the returns that varies slowly between pulses, and subtracting that slow variation from the pulse returns.

Alternatively, and advantageously, the moving target filter may be generated by calculating the covariance matrix of a set of pulses returned from a similar clutter scene by averaging over a group of range-cells, calculating the eigenvalues and associated normalized eigenvectors of this covariance matrix, selecting a chosen number of eigenvectors such that their associated eigenvalues are larger than those of any of the remaining eigenvectors, projecting the pulse-to-pulse variations in each range-cell onto these chosen eigenvectors, and subtracting that projection from the pulse returns.

The secondary returns may be produced by:

a) distributing main returns between appropriate target range cells;

b) deriving clutter-like returns which comprise contributions to the main pulse returns and which vary between successive pulses in a manner related to clutter;

c) comparing the amplitudes of the clutter-like returns and the primary returns to identify range cells over which these respective amplitudes have similar relative variations with range;

d) determining the phasor of the primary returns in each range cell, and optionally filtering the phasor-trend over groups of range cells;

e) combining the amplitude of the slowly varying returns in each range cell with the optionally filtered phasor trend of the primary returns in the corresponding range cell, to provide products which are the secondary returns.

The modified primary returns may be produced by removing from the primary returns, their projections onto the corresponding secondary returns. These projections may be calculated using a weighting related to the degree of correspondence between the amplitude's of the clutter-like varying trends and the primary returns.

This may be done by:

a) for each pulse calculating over the range interval a projection coefficient comprising a sum of products of primary returns, a range-dependent weighting factor and a complex conjugate of each orthogonalised secondary return; and

b) multiplying the projection coefficient by its associated secondary return to form a product, dividing that product by the total energy of the secondary return, and subtracting that product from the primary return to produce the modified primary returns.

The range dependent weighting factor may be binary in nature such that it acts as a gating function, or may be real valued.

The modified primary returns derived as stated above may then be used in a conventional manner by a target detection system. This may be carried out by:

a) preferably applying a moving target filter to the modified primary returns so that for each range value parts of the modified primary returns varying more rapidly from pulse to pulse than clutter returns are retained to produce filtered modified returns,

b) producing a Fourier transform of the filtered modified returns for every range value;

c) evaluating the Fourier transform's squared modulus to provide return power as a function of range and Doppler frequency; and

d) searching the power function for peaks projecting above neighbouring function regions.

The moving target filter applied to the modified primary returns may be implemented in a similar fashion to the moving target filter applied to the main returns as discussed earlier.

In a further aspect, the invention provides method of processing signals received from a scene, comprising the steps of:

a) producing from the received signals a set of main returns representative of the scene and distributed between a plurality of range cells; and

b) estimating a clutter component of the main returns; and

c) producing a set of primary returns comprising of residuals derived by removing the estimated clutter component from the main returns; characterised in that a set of modified primary returns is produced by:

c) estimating a component representative of clutter artifacts manifesting as a similarity between the primary returns and either the clutter component or the main returns , and

d) removing the clutter artifact component from the primary returns to produce the modified primary returns having reduced clutter artifacts.

In a further aspect the invention provides a computer program designed to run on a computer system and arranged thereon to implement a signal processing system, the system being arranged to:

a) receive signals representative of a scene that comprise a set of main returns distributed between a plurality of range cells; and

b) estimate a component of the main returns caused by clutter, and to produce a set of primary returns comprising of residuals derived by removing the estimated clutter component from the main returns;
characterised in that the system further includes:

c) means for estimating a component representative of clutter artifacts manifesting as a similarity between the primary returns and either the clutter component or the main returns, and

d) means for removing the clutter artifact component from the primary returns to produce the modified primary returns having reduced clutter artifacts.

The invention will now be described, by way of example only, with reference to the accompanying drawings, in which:

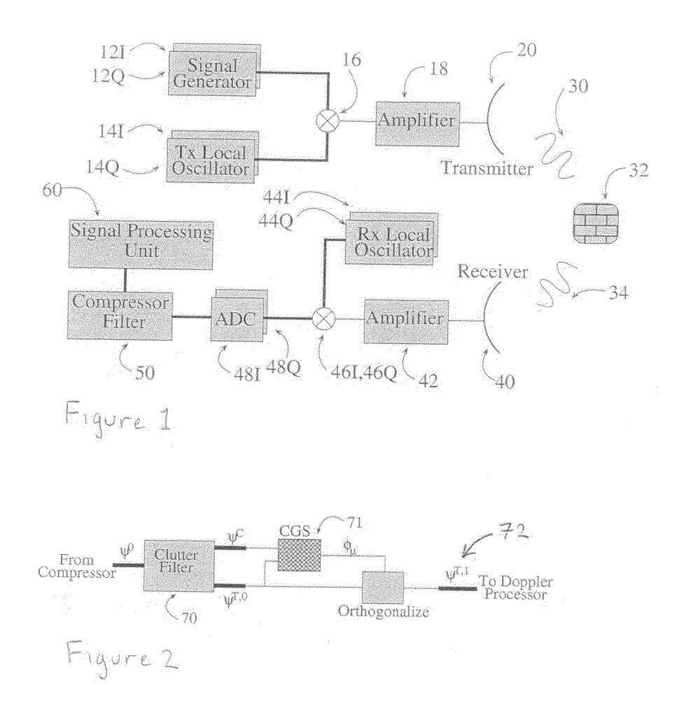

FIG. 1 is a block diagram of the imaging system apparatus upon which the current invention may be implemented;

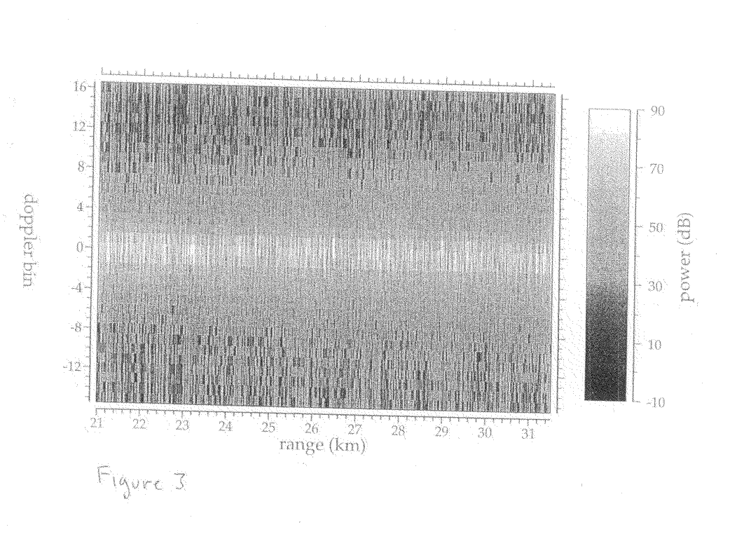

FIG. 2 is a block diagram of the signal processing of the invention;

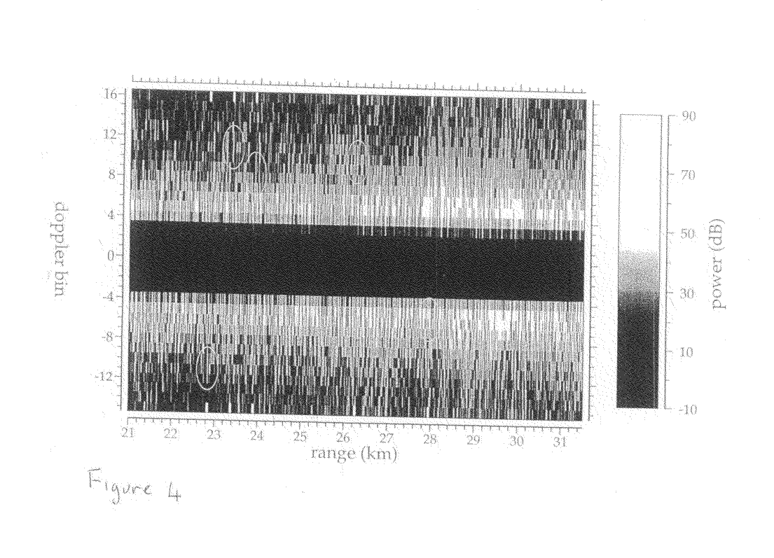

FIG. 3 is a range-Doppler image before being processed according to the invention;

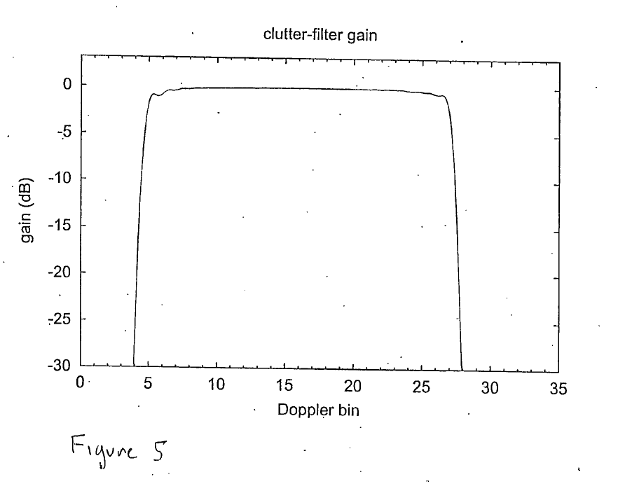

FIG. 4 is the range-Doppler image produced by removal of clutter returns;

FIG. 5 is a graph of the frequency-response of the clutter filter;

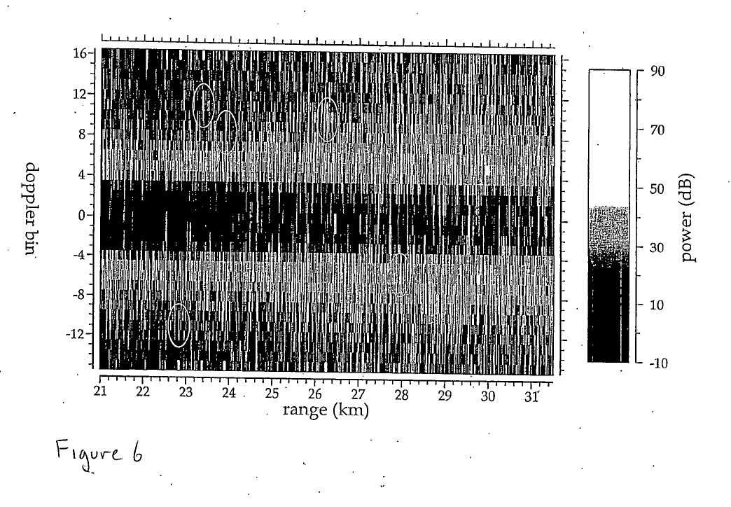

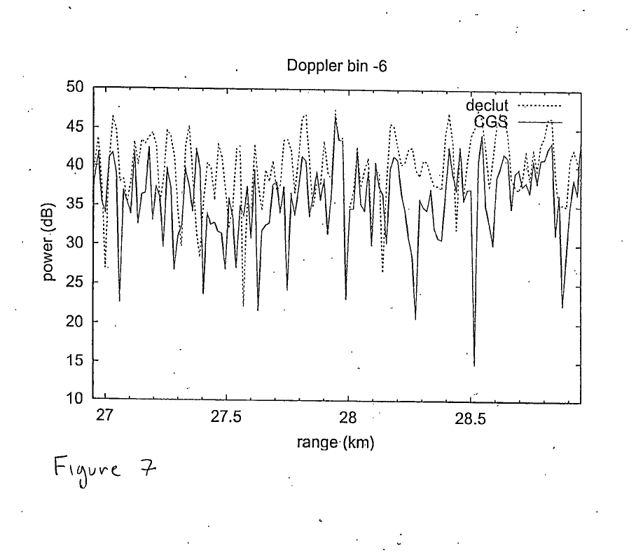

FIG. 6 is the range-Doppler image produced after removal of clutter artifacts

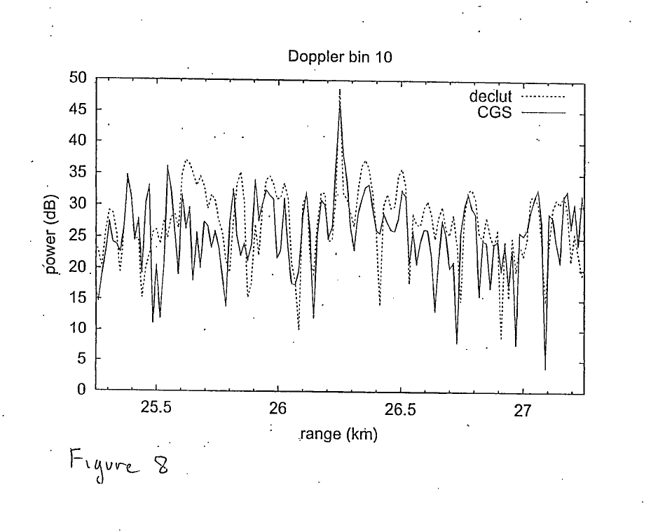

FIG. 7 is a graph of signal power showing the effect on a synthetic target signal having a Doppler frequency near the range of frequencies removed by the clutter filter, the graph showing a part processed signal and a fully processed signal according to the current invention;

FIG. 8 is a graph of signal power showing the effect on a synthetic target signal having a Doppler frequency further beyond the range of frequencies removed by the clutter filter, the graph showing a part processed signal and a fully processed signal according to the current invention.

In an embodiment of the current invention, the clutter artifacts are reduced in two successive steps. First, clutter-like variations in the returns between successive pulses in a given range cell are removed by a moving target filter. Second, clutter signals are estimated, and combined with the output of the moving target filter, to generate signals which resemble classes of clutter artifacts, and any component of these artifact signals that remains in the target-like return variations is removed.

Referring to FIG. 1, a radar system 10 in the form of a range-Doppler radar, and suitable for implementing the invention includes a signal generator 12 generating in-phase and quadrature (I&Q) components a transmitter local oscillator 14 comprising I&Q components, a mixer 16, a power amplifier 18 and a transmitter 20. It also includes a receiver 40, an amplifier 42, a receiver local oscillator 44 and mixer 46, I&Q analogue to digital converters (ADCs) 48I and 48Q, a compressor filter 50, and a signal processing unit 60. If receiver and transmitter are co-located, the transmitter local oscillator 14 may provide local oscillator signals for both reception and transmission and the receiver local oscillator 44 may be dispensed with.

The signal generator 12 produces an output signal consisting of a train of pulses with a bandwidth of 8 MHz. Each of these pulses is described by a complex function of time h(t). Using in-phase and quadrature mixers 16I and 16Q, the real and imaginary parts of this signal are mixed with and thereby modulate respectively an in-phase (I) 10 GHz local oscillator (LO) signal, and a quadrature-shifted (Q) version of the LO signal, generated by transmitter local oscillator 14 at outputs I and Q respectively. A modulated train of pulses results modulated by the sum of the in-phase and quadrature-shifted LO signals, and these pulses are then amplified by the amplifier 18 and output via transmitter 20.

When an electromagnetic disturbance from a radar pulse 30 strikes a target 32 such as a ship or aircraft, a proportion of the energy of the disturbance may be scattered at 34 towards the receiver 40. The scattered pulse 34 is received by receiver 40 and down-converted in frequency by mixing with the 10 GHz in-phase and quadrature LO signals from receiver local oscillator 44 using downconversion mixer 46I and 46Q and producing baseband signals. The output signals from the two mixers 46I and 46Q comprise real and imaginary parts of a complex signal which is the radar return. The signal from each of the mixers 46I and 46Q is sampled at regular intervals by respective ADCs 48I and 48Q producing a sequence of samples. The pairs of digitized samples from these two ADCs constitute real and imaginary parts of the main return.

In a radar transmitting compressible pulses described by a complex baseband modulation h(t), the imperfections of the radar transmitter mean that the transmitted electromagnetic pulse will be Re(h(t)e^{Iφ(t)}e^{1ωt}), where ‘Re’ denotes the real part. Thus, the transmitted pulses contain an unwanted extra modulation e^{iφ(t)}. When the transmitted electromagnetic pulse strikes a target or clutter object, a proportion of the electromagnetic signal is scattered back towards the radar antenna. The received signal is down-converted by mixing it with the in-phase and quadrature LO signals, which can also introduce unwanted modulations if the LO signals are not sufficiently stable. Hence, imperfections in the LO can introduce further phase shifts e^{-iθ(t)} on to the received signal. These baseband signals are then digitized and passed through a linear filter described by filter weights g(t).

In an ideal radar, the filter weights g(t) would correspond to the transmitted modulation h(t) in such a way as to compress the extended pulse described by h(t) into a pulse much more strongly concentrated in a single range cell. If the imperfections in the transmitter and receiver produce phase errors φ(t) & θ(t) that vary slowly over the duration of the transmitted pulse, then the output of the compressor filter will still be concentrated in a single range cell, without additional blurring between range cells. However, the effect of the phase errors will be to introduce an additional phase error on to the clutter and target signals that an ideal radar would attribute to each range cell. This phase error may vary significantly between range cells in the compressor output, and over the range swath covered by the radar. This means that each range cell in the output of the compressor filter will contain an error signal that has an amplitude that is approximately proportional to the clutter returns.

It is usual in a Doppler radar to search for moving targets by using a group of R pulses, and applying a set of frequency filters to the returns in corresponding range cells in successive pulses. Typically these moving target filters may be emulated using a Fourier transformation of the returns in each range cell. However, even when the Fourier transformation is combined with a carefully designed set of pulse-number dependent weights, each frequency filter will typically have non-zero response to variations well outside its nominal frequency. Hence, a filter tuned to detect relatively rapid variations between the pulses may still produce a significant response to a slowly varying clutter return that is sufficiently strong. If an identical frequency filter is applied to each range cell, then the amplitude of this unwanted signal will again vary with range in a manner very similar to the amplitude of the clutter itself.

The returns from the clutter may be estimated by using a set of moving target filters consisting of a set of filter weights w_{qμ}. These filter weights may be constructed in a number of ways such as: in terms of a Fourier Transformation; or from a set of orthogonal polynomials in the pulse-number μ, using a process of Gram-Schmidt Orthogonalisation; or from the Principal Components of the pulse to pulse clutter statistics. In each case, the clutter-like signals are modelled by a selecting a subspace of pulse to pulse variations from the space of all possible pulse to pulse variations. For the Fourier Transformation, this subspace is that of variations with the longest wavelengths; for the orthogonal polynomials it is the subspace of lowest-order polynomials; and for the Principal Component analysis, the subspace may typically be that associated with the largest eigenvalues of the clutter covariance matrix. These manipulations are straightforward for a skilled programmer to implement, as they involve known computational procedures. The clutter returns may be estimated in each range-cell τ by using an orthogonal and normalized basis of the clutter subspace as follows:

$${ψ}_{μ}^{C} ( τ ) = {\sum }_{q = 0}^{L} {w}_{q μ} {\sum }_{v = 1}^{R} {w}_{qv}^{*} {ψ}_{v}^{0} ( τ ) \qquad ( 1 )$$

where ‘*’ denotes complex conjugation.

Given such an estimate of the clutter returns, an initial estimate of the returns from moving targets can be constructed by subtracting the clutter returns from the main returns:

ψ_{μ}^{T,0}(τ)=ψ_{μ}⁰(τ)−ψ_{μ}^{C}(τ) (2)

However, imperfections in the radar and limitations in the selectivity of the filters formed by the w_{qμ} mean that ψ^{T,)}_{μ}(τ) also contains clutter artifacts. In accordance with the invention, it is useful to construct the following ratio of amplitudes:

A_{μ}(τ)=|ψ_{μ}^{T,0}(τ)|/|ψ_{μ}^{C}(τ)| (3)

Although the typical values of A_{μ}(τ) will depend on the level and nature of the imperfections in the radar system, it is expected that A_{μ}(τ) will be approximately constant for range cells i affected by clutter artifacts.

In order to make corrections to the complex-valued signals ψ^{T,0}_{μ}(τ), both a phasor and overall scaling to apply to the amplitude trend |ψ^{C}_{μ}(τ)| is then determined. If we were to choose the phasor in each range cell so as to minimize the power subtracted, then the phase of the secondary return in each range cell must be equal to that of ψ^{T,0}_{μ}(τ) itself. Accordingly, we define the quantity E_{μ}(τ) as follows:

E_{μ}(τ)=ψ_{μ}^{T,0}(τ)/|ψ_{μ}^{T,0}(τ)| (4)

Clearly, each E_{μ}(τ) has modulus unity.

The present embodiment then filters this phasor trend E_{μ}(τ) using a sliding window low-pass filter to produce a smoothed version:

$${F}_{μ} ( τ ) = \frac{{\sum }_{k = - r}^{r} {f}_{k} {E}_{μ} ( τ - k )}{{\sum }_{k = - r}^{r} {f}_{k}} \qquad ( 5 )$$

where the filter weights fₖ may typically have values (¼,½,¼) for r=1 or ( 1/7, 8/35, 9/35, 8/35, 1/7) for r=2. Naturally, this smoothing process may produce values of F_{μ}(τ) which have modulus less than unity. Other embodiments may employ the unsmoothed phasor trend E_{μ}(τ) directly, however.

The overall scale of the secondary returns can be determined by examining a group of N range cells, and calculating the average value of the amplitude ratio A_{μ}(τ):

$${\overline{a}}_{μ} = \frac{1}{N} {\sum }_{τ = 1}^{N} {A}_{μ} ( τ ) \qquad ( 6 )$$

In order to allow for range cells which contain targets of interest, and also to restrict attention to range-cells dominated by clutter artifacts, the current invention employs a weighting function, defined as follows:

$${Θ}_{μ} ( τ ) = \{ \begin{matrix}1 & {A}_{μ} ( τ ) < γ {\overline{a}}_{μ} \\ 0 & otherwise\end{matrix} \qquad ( 7 )$$

Hence, Ξ_{μ}(τ) should be constant and non-zero in range cells where the amplitude of clutter artifacts does not deviate strongly from the overall relative scale measured by a_{μ}. In typical usage, the parameter _{y} may be about three.

The secondary returns may now be constructed as follows, using the filtered phasor-trend F_{μ}(τ), the amplitude trend |ψ_{μ}(τ)|:

φ_{μ}(τ)=F_{μ}(τ)|ψ_{μ}^{C}(τ)| (8)

Clutter artifacts in Ψ^{T,0}_{μ}(τ) may reduced by constructing a projection coefficient onto the secondary returns, and subtracting the corresponding amount of the secondary return from ψ^{T,0}_{μ}(τ):

$${ψ}_{μ}^{T , 1} ( {τ}^{′} ) = {ψ}_{μ}^{T , 0} ( {τ}^{′} ) - {φ}_{μ} ( {τ}^{′} ) \frac{{\sum }_{τ = 1}^{N} {φ}_{μ}^{*} ( τ ) \{ {Θ}_{μ} ( τ ) {ψ}_{μ}^{T , 0} ( τ ) \}}{{\sum }_{τ = 1}^{N} {\vert {φ}_{μ} ( τ ) \vert}^{2}} \qquad ( 9 )$$

This expression uses the weight function Ξ_{μ}(τ) to limit the projection of each secondary function onto ψ^{T,0}_{μ}(τ) according to range cells which most strongly resemble clutter artifacts. Corrections are applied to all range cells where φ_{μ}(τ) is non zero.

The processed returns ψ^{T,1}_{μ}(τ) typically have a reduction in the background above which targets must be detected, as compared to the equivalent returns in which clutter artifacts have not been suppressed. The effect of processing upon returns from targets themselves is generally small, and significantly smaller than the accompanying reduction in background level, hence target visibility should be improved.

The process is shown as a high level block diagram in FIG. 2. The main returns, ψ⁰ are separated in clutter filter 70 into decluttered signal ψ^{T,0} and clutter estimate ψ^{C} using the process outlined in Equations 1 and 2. These signals are then processed 71 to calculate the secondary returns φ_{μ}, according to equations 3-8. The output ψ^{T,1} is then generated 72 using equation 9.

Target detection and extraction of target speeds may be performed by standard manipulations of the processed returns ψ^{T,1}_{μ}(τ) as output from equation 9. Typically this will involve taking the Fourier transform of the signals within each range cell τ, and across the pulses μ:

$${\sum }_{μ = 1}^{R} {ψ}_{μ}^{T , 1} ( τ ) {e}^{- 2 π i q μ / R}$$

in which the parameter q is related to the Doppler frequency of the target. More details of the detection process can be found in ‘Introduction to Radar Systems’ by MI Skolnik, 3rd edition, McGraw Hill 2001, chapter 3.

FIG. 3 shows a range-Doppler graph of simulated data generated based upon an airborne radar operating over land. The graph indicates the power received over a set of ranges and having a series of Doppler frequencies. The positive and negative Doppler frequency is shown on the vertical axis, and is measured in terms of Doppler bins, where each bin nominally contains the energy within a band of frequencies. In this case each bin is about 100 Hz wide. The brightness is used to indicate the detected power level according to the key on the right of the Figure. The data shown comprises of main returns from 32 pulses, and as such shows the data before processing according to the present invention, corresponding to Ψ⁰_{μ}. The bright horizontal strip in the centre corresponds to the clutter returns, it being at around zero Doppler.

FIG. 4 shows a range-Doppler graph of the same data as shown in FIG. 3, but having been passed through a clutter filter to remove the clutter elements. This corresponds to the primary returns, ψ^{T,0}_{μ}. The dark horizontal portion is evident, showing the low frequency parts heavily attenuated. Shown circled are synthetic targets. Note that the key on the right of the figure showing the power/brightness relationship is calibrated differently to the one used in relation to FIG. 3, in order to better highlight the targets.

FIG. 5 shows the frequency response of the moving target, or clutter filter used to generate the primary returns, ψ^{T,0}_{μ}. Again, the frequency is shown in terms of Doppler bins.

FIG. 6 shows a range-Doppler graph of the same data having been processed according to the invention. The data therefore corresponds to the modified primary returns, ψ^{T,1}_{μ}. The key to the right of the figure is calibrated as for that used in FIG. 4. It will be observed that the area around the zero Doppler region is somewhat brighter than that shown in FIG. 4. This indicates that the operation of the invention has increased the noise levels in that area. For this reason the current embodiment filters the modified primary returns using a moving target filter before passing the returns on to a target detection system. This step is not essential however.

FIG. 7 shows a graph of received power with range taken at a particular Doppler bin. In this case the data has been taken from Doppler bin-6 which, looking back at FIG. 5, can be seen to be on the edge of the passband transition of the clutter filter. The particular range band has been chosen because there is a synthetic target present within it. The graph has two traces: the dotted one (marked “declut”) is a plot of the signal power within a limited range, as detected directly from the primary returns, i.e. a part of that data shown in FIG. 4; the solid trace (marked “CGS”) shows the power in the corresponding modified primary returns, i.e., after processing the primary returns according to the invention. A target is present at the 28 km range point. It will be seen that the power in the signal corresponding to the target has not been significantly affected by the processing of the invention, as the two traces are at the same level. However, the signal surrounding the target has been reduced in the processed signal as compared to the unprocessed one. Thus, the signal to noise ratio has been increased, thus leading to a better chance of detecting the target.

FIG. 8 again shows a graph of received power with range, this time using data taken from Doppler bin 10, which is not so close to the edge of the clutter filter passband. As with FIG. 7, two traces are shown, the dotted one being before processing according to the invention, and the solid one after processing. The power relating to the synthetic target, at around a range of 26.25 km, is seen to be substantially unaffected by the processing, whereas the surrounding signal has been, on average, slightly reduced in power. This again will lead to a better chance of detecting the target in subsequent processing.

The invention as described in the foregoing description can clearly be evaluated by an appropriate computer program on a carrier and running on a conventional computer system. Such a program is straightforward for a normally skilled programmer to implement without requiring invention, because the equations involve well-known computational procedures. Such a program and system will therefore not be described further.

The skilled person will be aware that other embodiments within the scope of the invention may be envisaged, and thus the invention should not be limited to the embodiments as herein described.

1. An electronic signal processing system for processing signals received from a scene, including:
a) means for producing from the received signals a set of main returns representative of the scene and distributed between a plurality of range cells;
b) means for estimating a clutter component of the main returns; and
c) means for producing a set of primary returns comprising of residuals derived by removing the estimated clutter component from the main returns;
characterised in that the system is arranged to produce a set of modified primary returns by further including:
d) means for estimating a component representative of clutter artifacts manifesting as a similarity between the primary returns and either the clutter component or the main returns, and
e) means for removing the clutter artifact component from the primary returns to produce the modified primary returns having reduced clutter artifacts.

2. A signal processing system as claimed in claim 1 wherein the received signas take the form of pulses.

3. A system as claimed in claim 2 wherein the means for estimating the component representative of clutter artifacts includes a means for identifying a first set of range cells over which the primary return amplitudes vary in a manner related to the clutter returns, and further including means for processing over a second set of range cells the main returns to produce secondary returns representative of the clutter artifacts in the primary returns.

4. A system as claimed in claim 3 wherein the system further includes means for removing from the primary returns a contribution thereto varying with range in a substantially similar way as the secondary returns and thereby generating modified primary returns with reduction in clutter artifacts.

5. A system as claimed in claim 3 wherein the means for processing the main returns to generate the secondary returns includes means for combining the amplitude of the clutter-like returns in each range cell with the phase of the primary returns in corresponding range cells.

6. A system according to claim 4 wherein the means for removing from the primary returns the contribution varying in the same manner as the secondary returns includes:
a) means that, for each pulse, calculates over the second set of range cells a projection coefficient comprising a summation of the product of: the primary returns, a complex conjugate of their associated normalised secondary returns and a pulse and range dependent weighting factor;
b) means to multiply the projection coefficient by the normalised secondary return to form a product and to subtract that product from the primary return to produce the modified primary returns.

7. A system as claimed in claim 6 arranged to identify those range cells within the first set of range cells wherein the ratio of the amplitudeof the primary return to the clutter return in a given range cell is below a predetermined threshold, and limiting the summation in point a) of claim 6 to the identified range cells.

8. A system as claimed in claim 1 wherein the system is arranged to process the modified primary returns using a moving target filter before passing the processed modified primary returns to a target detection system.

9. A system according to claim 1 wherein the signals received from the scene have been arranged to vary in frequency with time in such a way that the signals are compressible by filtering.

10. A method of processing signals received from a scene, comprising the) steps of:
a) producing from the received signals a set of main returns representative of the scene and distributed between a plurality of range cells; and
b) estimating a clutter component of the main returns; and
c) producing a set of primary returns comprising of residuals derived by reffiefing the estimated clutter component from the main returns;
characterised in that a set of modified primary returns is produced by:
c) estimating a component representative of clutter artifacts manifesting as a similarity between the primary returns and either the clutter component or the main returns, and
d) removing the clutter artifact component from the primary returns to produce the modified primary returns having reduced clutter artifacts.

11. A method as claimed in claim 10 wherein the received signals take the form of pulses.

12. A method as claimed in claim 11 wherein the estimation of the component representative of clutter artifacts is done by identifying a first set of range cells over which the primary return amplitudes vary in a manner related to the clutter returns, and processing over a second set of range cells the main returns to produce secondary returns representative of the clutter artifacts in the primary returns.

13. A method as claimed in claim 12 wherein a contribution thereto varying with range in the same way as the secondary returns is removed from the primary returns, thereby generating modified primary returns with reduced clutter artifacts.

14. A method as claimed in claim 12 wherein the processing of the main returns to generate the secondary returns includes combining the amplitude of the clutter-like returns in each range cell with the phase of the primary returns in corresponding range cells.

15. A method as claimed in claim 13 wherein the contribution varying in the same manner as the secondary returns is removed from the primary returns by:
a) for each pulse, calculating over the second set of range clels a projection coefficient comprising a summation of the product of: the primary returns, a complex conjugate of their associated normalised secondary returns and a pulse and range dependent weighting factor; and
b) multiplying the projection coefficient by the normalised secondary return to form a product and to subtract that product from the primary return to produce the modified primary returns.

16. A method as claimed in claim 15 in which those range cells within the first set of range cells wherein the ratio of the amplitude of the primary return to the clutter return in a given range cell is below a predetermined threshold are identified, and the summatio in point a) of claim 15 is limited to the identified range cells.

17. A method as claimed in claim 10 wherein the modified primary returns are processed using a moving target filter before passing the processed modified primary returns to a target detection system.

18. A method according to claim 10 wherein the signals received from the scene vary in frequency with time in such a way that the signas are compressible by filtering.

19. A computer program designed to run on a computer system and arranged thereon to implement a signal processing system, the system being arranged to:
a) receive signals representative of a scene that comprise a set of main returns distributed between a plurality of range cells; and
b) estimate a component of the main returns caused by clutter, and to produce a set of primary returns comprising of residuals derived by removing the estimated clutter component from the main returns;
characterised in that the system includes:
c) means for estimating a component representative of clutter artifacts manifesting as a similarity between the primary returns and either the clutter component or the main returns, and
d) means for removing the clutter artifact component from the primary returns to produce the modified primary returns having reduced clutter artifacts.

20. A computer program as claimed in claim 19 wherein the received signals are derived from a plurality of pulses.

21. A computer program as claimed in claim 20 wherein the means for estimating the component representative of clutter artifacts includes a means for identifying a first set of range cells over which the primary return amplitudes vary in a manner related to the clutter returns, and further includes means for processing over a second set of range clels the main returns to produce secondary returns representative of the clutter artifacts in the primary returns.

22. A computer program as claimed in claim 21 wherein the system further inclues means for removing from the primary returns a contribution thereto varying with range in a substantially similar way as the secondary returns and thereby generating modified primary returns with reduction in clutter artifacts.

23. A computer program as claimed in claim 21 wherein th means for processing the main returns to generate the secondary returns includes means for combining the amplitude of the clutter-like returns in each range cell with the phase of the primary return in corresponding range cells.

24. A computer program according to claim 22 wherein the means for removing from the primary returns the contribution varying in the same manner as the secondary returns includes:
a) means that, for each pulse, calculates over the second set of range cells a projection coefficient comprising a summation of the product of: the primary returns, a complex conjugate of their associated normalised secondary returns and a pulse and range dependent weighting factor;
b) means to multiply the projection coefficient by the normalised secondary return to form a product and to subtract that product from the primary return to produce the modified primary returns.

25. A computer program as claimed in claim 24 arranged to identify those range cells within the first set of range cells wherein the ratio of the amplitude of the primary return to the clutter return in a given range cell is below a predetermined threshold, and limiting the summation in point a) of claim 24 to the identified range cells.
